(19) United States
(12) Patent Application Publication
(10) Pub. No.: US 2018/0006412 A1
(43) Pub. Date: Jan. 4, 2018

(54) Monorail Power Strip for Shelving LED Lighting

(71) Applicant: Display Source Alliance, LLC, Mesquite, TX (US)

(72) Inventors: Henry C. Leaverton, Fort Worth, TX (US); Thomas H. Leaverton, Fort Worth, TX (US)

(21) Appl. No.: 15/611,255

(22) Filed: Jun. 1, 2017

Related U.S. Application Data
(60) Provisional application No. 62/357,826, filed on Jul. 1, 2016.

(51) Int. Cl. H01R 25/14; F21V 21/35; A47F 11/10; F21V 33/00; A47F 3/00

(52) U.S. Cl. CPC H01R 25/14; F21V 33/0012; A47F 3/001; A47F 11/10; F21V 21/35

(57) ABSTRACT

A monorail power strip system includes a ‘T’-shaped monorail power strip (MPS), a power supply plug, and a power access plug. The MPS includes a vertical monorail member and a horizontal support member. The power supply plug supplies power to the MPS from an electrical source. The power access plug retrieves and transmits power from the MPS to provide easily changeable and customizable power access for electrical accessories. The power access plug and the power access plug are slideably-positionable along the length of the vertical monorail member of the MPS.

### CLAIM OF PRIORITY

This application claims benefit of priority from U.S. Provisional Application No. 62/357,826 entitled “Monorail Power Strip for Shelving LED Lighting,” filed on Jul. 1, 2016, the entire contents of which is hereby incorporated by reference for all purposes.

### TECHNICAL FIELD

This invention relates to power outlet solutions, and more particularly to power strip system and apparatus that provide easily changeable and customizable power access for electrical accessories such as LEDs.

### BACKGROUND

Lighting and other powered features for product display shelves (for example, light emitting diode (LED) strip lighting and other types of lighting) typically use multiple power outlets (or multi-outlet power strips) and require running many electrical cables from the power outlets to provide power for the lighting. Obtaining power in this manner for the lighting can be cumbersome and not easily changeable/customizable for various product display shelf options and physical locations.

### SUMMARY

The present disclosure describes a monorail power strip for shelving electrical accessories such as light emitting diode (LED).

In a particular implementation, a power strip system includes a ‘T’-shaped monorail power strip (MPS), a power supply plug, and a power access plug. The MPS includes a vertical monorail member and a horizontal support member. The power supply plug supplies power to the MPS from an electrical source. The power access plug retrieves and transmits power from the MPS to provide easily changeable and customizable power access for electrical accessories. The power access plug and the power access plug are slideably-positionable along the length of the vertical monorail member of the MPS.

Other implementations of this aspect can include corresponding computer systems, apparatuses, and computer programs recorded on one or more computer-readable media/storage devices, each configured to perform actions of methods associated with the described implementations. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

The subject matter described in this specification can be implemented in particular implementations so as to realize one or more advantages as will be understood from this disclosure and those of ordinary skill in the art. For example, first, the described monorail power strip for shelving LED lighting allows multiple power plugs for shelving LED lighting to be easily added, removed, or adjusted with finger force. Second, the monorail power strip can easily be adhered (for example, using double-sided tape, other adhesive, countersunk screws, and other fastening means consistent with this disclosure) to various surfaces to allow easily customizable power supply location options. Third, the monorail power strip can also be cut to length to allow for customizable power supply implementations. Fourth, built in circuitry provides a safeguard for inadvertent backwards power plug attachment to the monorail power strip. Fifth, built in computational logic/network interfaces can allow the power plugs to be programmed/controlled to provide customizable lighting effects and the like. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a perspective view of an example monorail power strip system (MPSS) for shelving LED lighting, according to an implementation.

FIG. 2A is a perspective view of a rendering of a power plug attached to a monorail power strip (MPS), according to an implementation.

FIG. 2B is a perspective view of a rendering of an MPS, according to an implementation.

FIG. 2C is a perspective view of a rendering of an alternative MPS, according to an implementation.

FIGS. 3A and 3B are renderings of a top view and a cross-sectional view of a power plug attached to the MPS of FIGS. 2A and 2B, according to an implementation.

FIG. 4 is a cross-sectional view of the MPS of FIG. 2B, according to an implementation.

FIG. 5 is a bottom perspective rendering of a power plug, according to an implementation.

FIG. 6 is an exploded perspective rendering of a power plug, according to an implementation.

FIG. 7 is a perspective rendering of an example internal electrical/computational component of a power plug, according to an implementation.

FIG. 8 is a block diagram of an exemplary computer that can be used with a MPSS for shelving LED lighting, according to an implementation.

Like reference numbers and designations in the various drawings indicate like elements.

### DETAILED DESCRIPTION

The following detailed description is presented to enable any person skilled in the art to make, use, and/or practice the disclosed subject matter and is provided in the context of one or more particular implementations. Various modifications to the disclosed implementations will be readily apparent to those skilled in the art, and the general principles defined herein may be applied to other implementations and applications without departing from the scope of the disclosure. Thus, the present disclosure is not intended to be limited to the described and/or illustrated implementations but is to be accorded the widest scope consistent with the principles and features disclosed herein.

For the purposes of this disclosure, the terms “real-time,” “real time,” “realtime,” “real (fast) time (RFT),” “near(ly) real-time (NRT),” “quasi real-time,” or similar terms (as understood by one of ordinary skill in the art), and if applicable, mean that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, and/or transmit the data.

Lighting, related components/elements, and other powered features for product display shelves (for example, light-emitting diode (LED) strip lighting or other types of lighting) are used to illuminate a style of store fixture referred to as Front End Merchandisers (FEM). FEM's are used in the front of most stores (for example, grocery, retail, etc.) in the areas adjacent to the checkout registers in the front of the store. FEMs typically use multiple power outlets (or multi-outlet power strips) and require running many electrical cables from the power outlets to provide power for the lighting. Obtaining power in this manner for the lighting can be cumbersome and not easily changeable/customizable for various product display shelf options and physical locations. For example, changing a power supply source for a LED light strip or adding a new LED light strip can require adding/replacing a power outlet, the use of tools, the need to move a display shelf to accommodate power needs, and the like. As another example, moving a display shelf using current shelf lighting power supplies can require an inordinate amount of effort to re-route/move power cables and power supplied to support existing shelf lighting.

The following disclosure describes a monorail power strip system (MPSS)/apparatus to supply power to multiple lighting (and other powered features) of product display shelves. As will be appreciated by those of ordinary skill in the art, while the following disclosure focuses on LED lighting with product display shelves, the described apparatus can be used to provide power to other powered features other than lighting (for example, electric motors to move display elements, noise makers, motion detectors, and the like) that can be used with display shelving as well as for uses other than those associated with display shelving (for example, computer components, home audio/visual equipment, and the like).

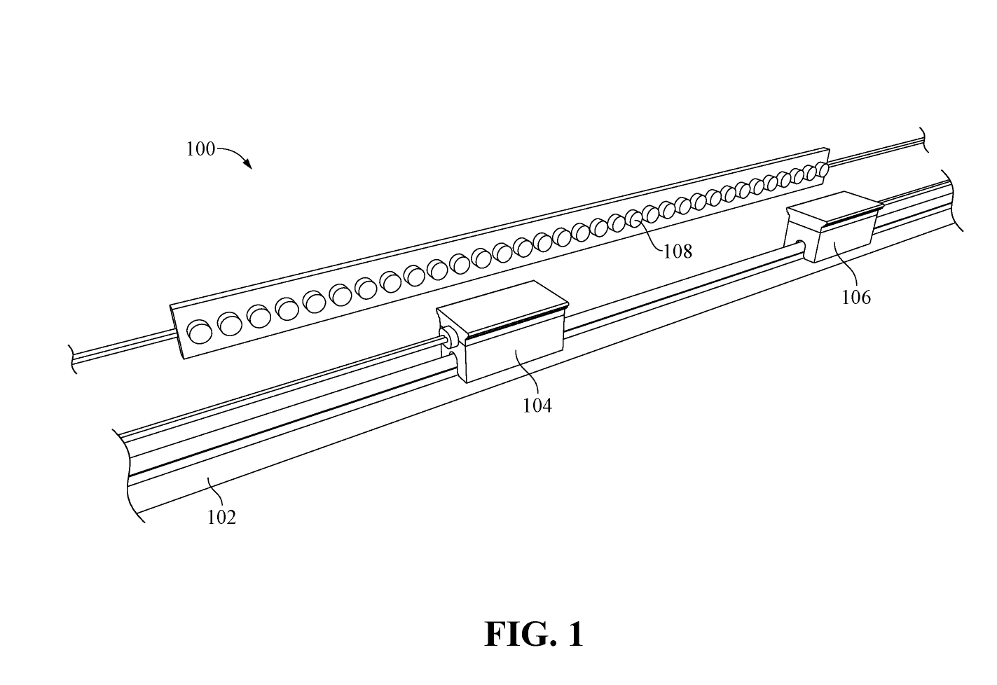

FIG. 1 is a perspective view of an example monorail power strip system (MPSS) 100 for shelving LED lighting, according to an implementation. A typical MPSS 100 includes a ‘T’-shaped monorail power strip (MPS) 102, power supply plug 104, power access plug 106, and LED light strip 108 attached to the power access plug 106. The power supply plug 104 is attached to the MPS 102 to provide power to the MPS 102 (for example, from a connected 12-volt DC transformer in various wattages—not shown). The power access plug 106 is attached to the MPS 102 to feed power to the attached LED light strip 108. In some implementations, the LED light strip 108 can be substituted with any electrical accessory receiving power from the MPS 102 using a power access plug 106.

In typical implementations, the power supply plug 104 does not contain all the components of the power access plug 106. For example, the power supply plug 104 can be configured without a resettable fuse, diode bridge/bridge rectifier, bi-polarity/computational logic, etc. (see below for additional detail). However, in some implementations, the power supply plug 104 and the power access plug 106 can be the same type of plug but tasked for different purposes (power supply versus power access) that can be controlled by internal electronic/computational logic in the various plug types. In some implementations, the color of the different plugs (for example the casing), the size, the shape, the texture, and the like can be different to distinguish between the purpose of the plugs and to avoid confusion. In other implementations, the color of the wires connected to different plugs can be different to distinguish between the purposes of the plugs. For example, the pair of wires 105 can be two red wires to indicate that the plug connected to them is the power supply plug 104. The other pair of wires 107 can be one red and one black to indicate that the plug connected to them is the power access plug 106.

While each of the power supply plug 104 and the power access plug 106 are shown with integral wiring, in other implementations, a power connector (for example a barrel connector, USB, or other type of power connector) can be used to attach to the power supply plug 104 and the power access plug 106. In some implementations, the power connectors can be of different types or sizes depending on whether the plug is a power supply plug 104 or a power access plug 106. For example, a power supply plug 104 can have a smaller barrel connector to prevent a power access plug component from plugging into the power supply plug 104.

The power supply plug 104 and the power access plug 106 can snap onto the MPS 102 at any convenient position and can be slideably-positioned along the length of the MPS 102 using finger pressure. Removal of the power supply plug 104 and the power access plug 106 can be performed by grasping a plug with fingers (or an appropriate grasping tool) and pulling the plug straight upward and away from the MPS 102.

The MPS 102 typically supports one power supply plug 104 and one or more power access plugs 106 as long as the power draw from attached lighting components does not exceed the power supplied by the power supply plug 104. Power is supplied along the length of the MPS 102 through two conductive electrode strips (for example, made of copper, aluminum, etc.) that run the length of the MPS 102 along the sides of a vertical monorail member/leg. In typical implementations, the MPS can also be cut to varying lengths to allow for customizable power supply implementations.

In some implementations, multiple MPS 102s can be “daisy chained” using, for example, a connected set of power supply plugs 104 (not illustrated). In this way, one power supply can support multiple MPS 102s and many attached devices requiring power.

In some implementations, an end cap (not illustrated) can be configured to be fastened to one or both ends of the MPS 102 in order to prevent a power supply plug 104 or a post access plug 106 from sliding off an end of the MPS 102. The end cap can be made of rubber, plastic, etc. to also prevent shorting of the electrode strips by a conductive object (for example, a metal display shelf element) touching the end of the MPS 102.

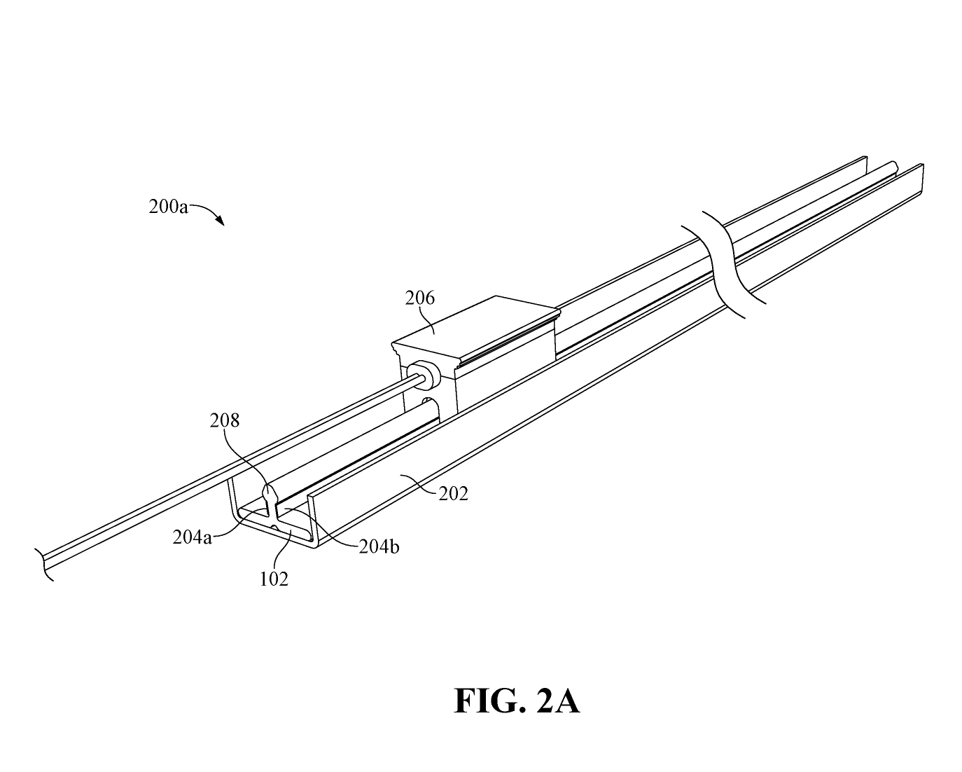

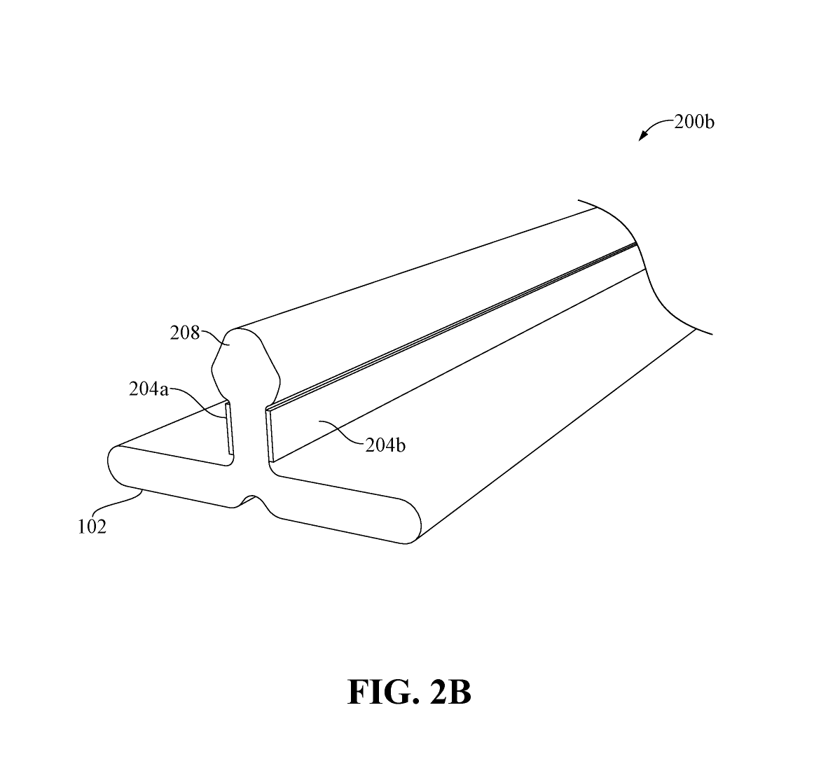

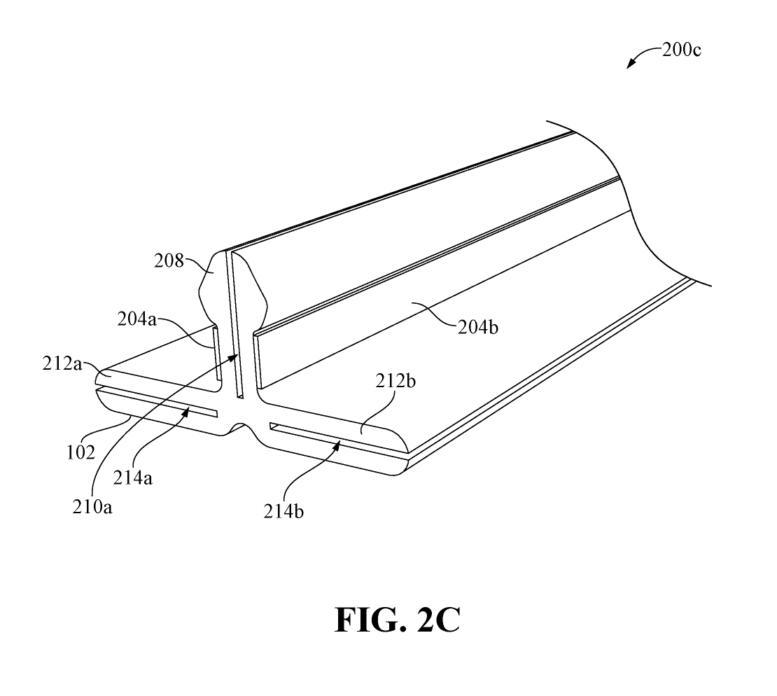

FIG. 2A is a perspective view 200a of a rendering of a power plug 206 (either a power supply plug 104 or power access plug 106) attached to an MPS 102, according to an implementation. The MPS 102 is illustrated as coupled (for example, using double-sided tape or other adhesive) with a “C”-channel 202 (for example, a display shelving component) to protect the conductive electrode strips along the “T” rail from being contacted by objects other than the connectors. In other implementations, the “C”-channel 202 can be omitted as the MPS 102 can be directly adhered (as described above) to various surfaces.

The illustrated “C”-channel can be secured in a number of ways to various surfaces/structures, such as by welding, screws, bolts, clips, clamps, or other means. In typical implementations, the “C”-channel is made of plastic, steel, aluminum, or wood.

As illustrated, the MPS 102 is configured of a non-conductive material (for example, plastic, rubber, etc.) with conductive electrode strips 204a and 204b that run the length of the MPS 102 on both sides of a vertical monorail member/leg 208 to receive/provide power of differing polarity from/to the attached power plug 206, respectively.

FIG. 2B is a perspective view 200b of a rendering of MPS 102, according to an implementation. In typical implementations, the electrodes 204a and 204b are adhered to the sides of the vertical monorail member 208 using an adhesive. For example, in a possible implementation, the electrode strips 204a and 204b can be adhered with an adhesive to the MPS 102 during an extrusion of the MPS 102. The vertical monorail member 208 is flared in its upper portion to engage springily-biased clips of the power plug 206 (described in detail below) to secure the power plug 206 to the MPS 102. Those of ordinary skill in the art will appreciate that the illustrated shape is only one possible shape that will permit securing of the power plug 106 to the MPS 102. Other shapes consistent with this disclosure are also considered to be within the scope of this disclosure.

In typical implementations, the MPS 102 has a volume per inch of ABS plastic of 0.119 Cu. In. In these implementations, the electrode strips 204a and 204b are typically 0.125 in. wide and 0.010 in. thick. The size and thickness of the electrode strips 204a and 204b can vary depending upon implementation.

FIG. 2C is a perspective view 200c of a rendering of an alternative MPS 102, according to an implementation. In FIG. 2C, a notch 210a has been configured into the vertical monorail member 208 to provide an outward spring bias in relation to the sides of the vertical monorail member 208 (causing the sides of the vertical monorail member to flare outward) to more securely engage with the power supply plug 104 or power access plug 106. This notch would typically extend the length of the vertical monorail member 208, but in some implementations, could be configured to extend only particular lengths of the vertical monorail member 208. This additionally provided spring bias can act to permit a more secure engagement between the power plug 206 and the MPS 102. In some other implementations, one or both of horizontal support members 212a/212b can also have a notch (e.g., 214a/214b) similar to notch 210a configured into their structures. Notches 214a/214b would provide an upward spring bias in relation to the upper surface of a horizontal support member (212a or 212b) causing the upper surface of the horizontal support member (212a or 212b) to flare upward and to more securely engage with the power supply plug 104 or power access plug 106. The notches in the horizontal support members (212a or 212b) can be configured to minimize/eliminate any spring bias directed to the bottom surface of the horizontal support members (212a or 212b) (e.g., the notch can be configured closer to the upper surface of the horizontal support members (212a or 212b)).

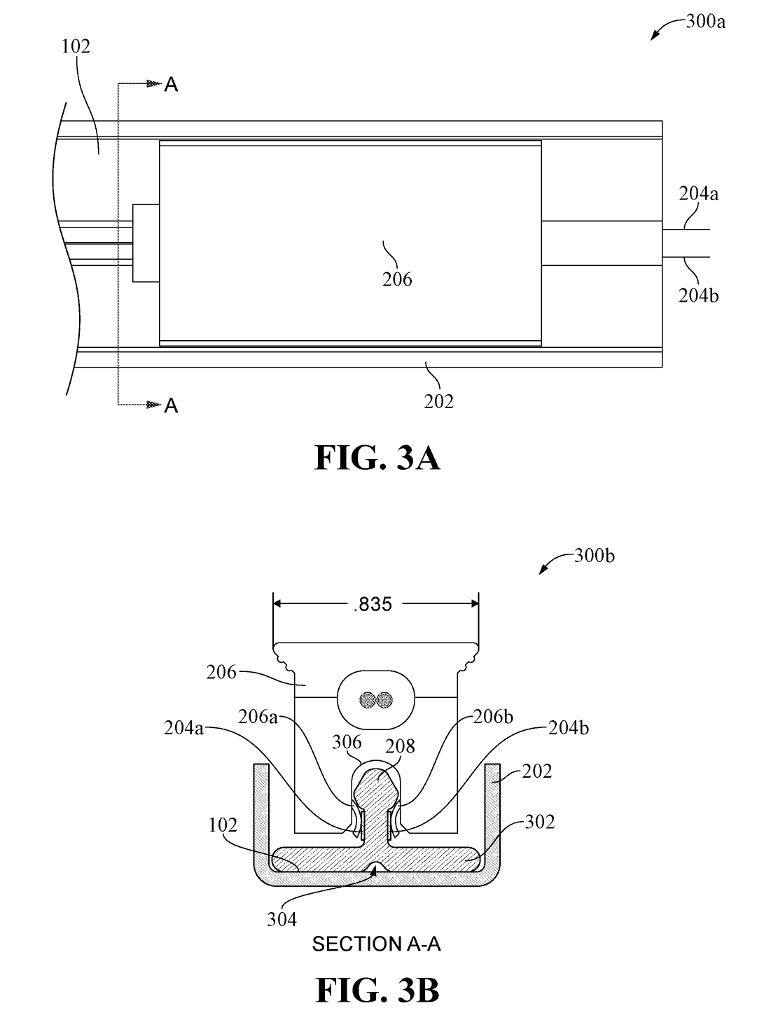

FIGS. 3A and 3B are renderings of a top view 300a and a cross-sectional view 300b of a power plug attached to the MPS 102 of FIGS. 2A and 2B, according to an implementation. In FIG. 3B, power plug 206 is shown “snapped” onto the vertical monorail member 208 of the MPS 102. Electrodes 206a and 206b (for example, copper spring contacts) are shown engaged through spring biasing with electrode strips 204a and 204b, respectively. Opening 306 (on either end of power plug 206) permits the power plug 206 to be slideably positioned along the length of the MPS 102 on the vertical monorail member 208. MPS 102 is configured with a base section 302 that can be adhered to various surfaces (for example, using double-sided tape, adhesive, or other fastening means described above). Groove 304 is typically an artifact of manufacturing to permit cooling of an extruded MPS 102 to ensure a flat bottom surface. In some implementations, groove 304 can be used as an attachment point for adhesive, adhesive strip, etc. to better secure the MPS 102 to a surface. In other implementations, the MPS 102 can be configured without the groove 304 to provide a flat bottomed surface, multiple parallel grooves (e.g., three parallel grooves similar to groove 304), one or more grooves that instead traverse perpendicular/diagonal to illustrated groove 304 (with one or more grooves 304 either present or absent), and other possible combinations depending upon the intended use of the MPS 102.

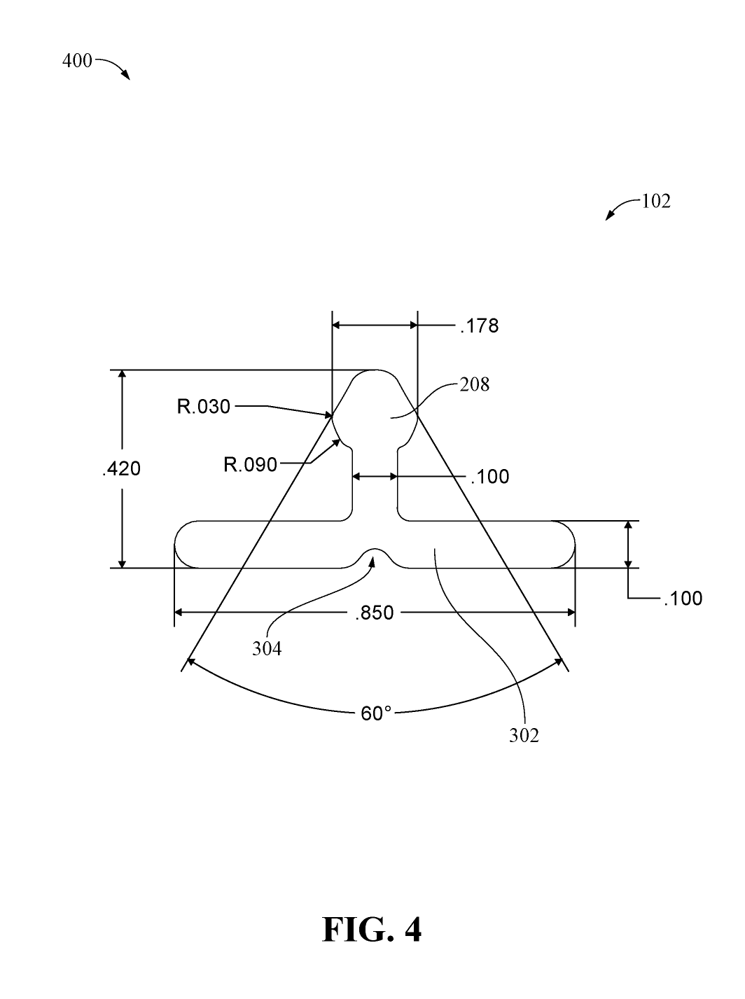

FIG. 4 is a cross-sectional view 400 of the MPS 102 of FIG. 2B, according to an implementation. FIG. 4 provides example engineering dimensions for a typical implementation of an MPS 102. As will be appreciated by those of ordinary skill in the art, the provided dimensions can be varied and still be within the scope of this disclosure. Varying dimensions consistent with this disclosure are considered to be within the scope of this disclosure.

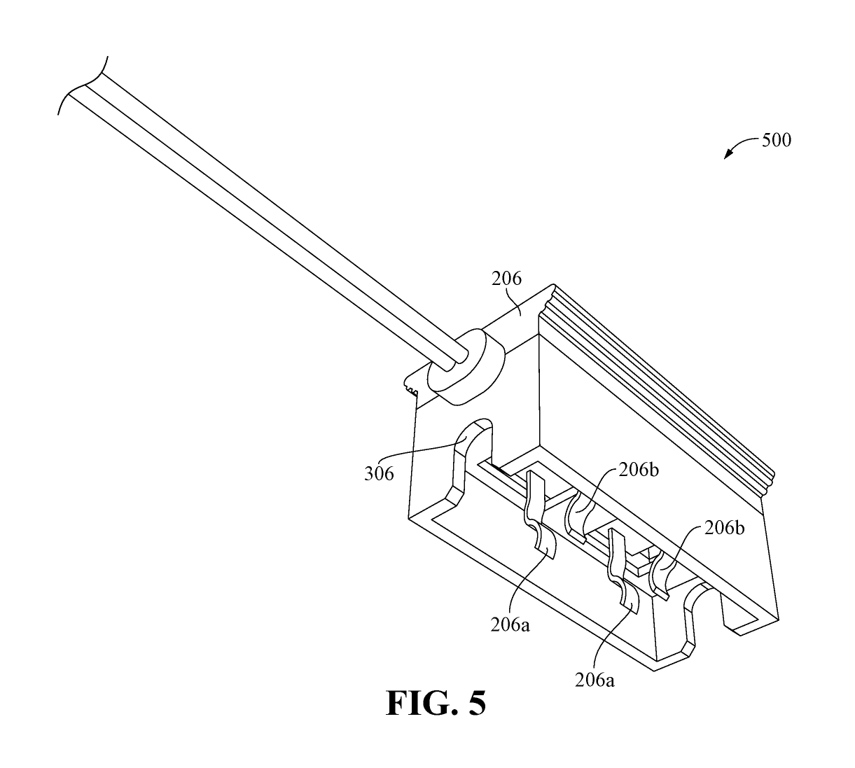

FIG. 5 is a bottom perspective rendering 500 of a power plug, according to an implementation. As illustrated, pairs of electrodes 206a and 206b (positioned on each side of power plug 206) are used to engage with the MPS 102 and to secure the power plug 206 to the MPS 102 and to engage with electrode strips 204a and 204b positioned on the sides of the vertical monorail member 208. The dual pairs of opposite electrodes (206a and 206b) provide an inward spring bias that causes the dual electrodes 206a and 206b to clamp to the vertical monorail member 208 and against electrode strips 204a and 204b. The dual pairs of electrodes 206a and 206b, provide additional stability when clamped to the MPS 102. Either or both of electrodes 206a and 206b provide/retrieve power to/from the MPS 102 electrode strips 204a and 204b, respectively. In some implementations, the electrodes 206a and 206b can be configured (not illustrated) with screw-type adjustment mechanisms, springs between the power plug 206 housing and a particular electrode, and the like to provide additional clamping tension to the MPS 102.

While illustrated with two pairs of electrodes 206a and 206b, in other implementations, a single pair or three or more pairs of electrodes 206a and 206b can be implemented with respect to the power plug 206. In another implementation, a set of springily-biased electrode-like clamps can be included in addition to the two pairs of electrodes 206a and 206b. The additional electrode like clamps can be configured to clamp more securely to the flared portion of the vertical monorail member 208 but not be used to provide/retrieve power from electrode strips 204a and 204b.

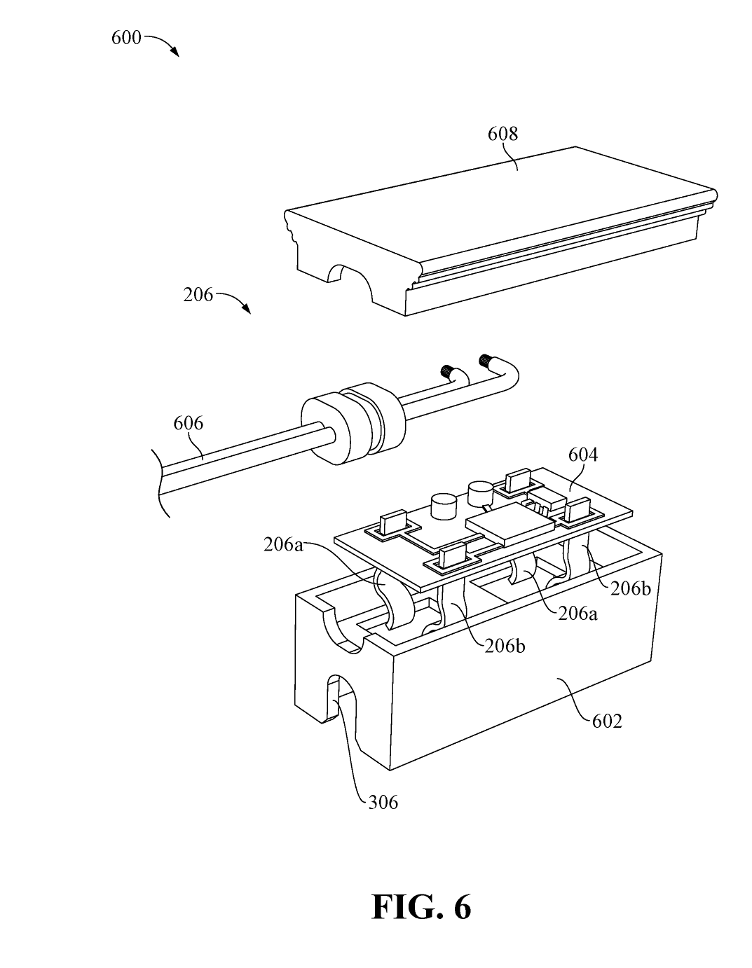

FIG. 6 is an exploded perspective rendering 600 of a power plug 206, according to an implementation. The power plug 206 includes a housing 602, internal electrical/computational component 604, internal wiring 606, and housing cap 608. Housing 602 provides support for the internal electrical component 604 and internal wiring 606. Housing cap 608 is attached to the housing 602 and prevents the internal wiring 606 from being pulled out of the power plug 206. In some implementations, housing cap 608 can be secured to the housing 602 using, for example, an adhesive, sonic welding, a clip-type assembly configured into the housing 602 and the housing cap 608, or a fastener(s) (for example, a screw) that can be configured to secure together the housing 602, internal electrical/computational component 604, and the housing cap 608.

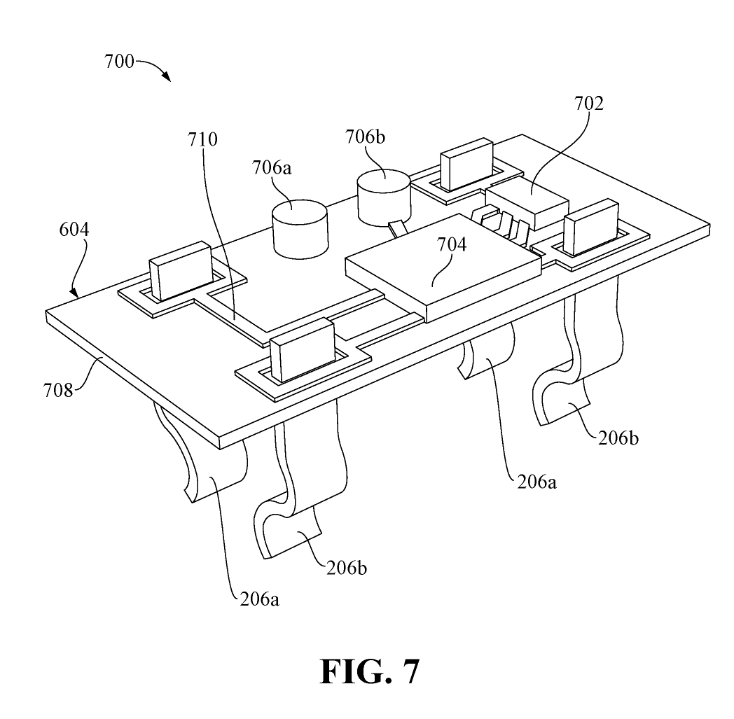

The internal wiring 606 is used to provide/retrieve power from/to the power plug 206, respectively. The internal wiring is attached to electrodes on the internal electrical/computational component 604 (refer to FIG. 7 for additional detail).

The internal electrical/computational component 604 is configured to provide/retrieve electrical power from/to the power plug 206. High-level functionality can include a resettable fuse, built-in bi-polarity logic, programmable computational logic to provide customizable lighting features, and networking functionality to enable the power plug 206 to communicate with other power plugs 206 or various computing devices (refer to FIG. 7 for additional detail).

FIG. 7 is a perspective rendering 700 of an example internal electrical/computational component 604 of a power plug 206, according to an implementation. The internal electrical/computational component 604 contains pairs of electrodes 206a and 206b, wiring attachments 706a and 706b, a resettable fuse 702, bi-polarity functionality 704, and computational logic (not illustrated—including one or more of a microprocessor, memory storage (RAM/ROM, network components, etc.) providing various functions related to the internal electrical/computational component 604, and printed circuit board (PCB) 708.

Each corresponding pair of electrodes 206a and 206b are arranged in parallel on either side of the central axis of the internal electrical/computational component 604 such that each corresponding pair of electrodes 206a and 206b will be situated on opposite sides of the above-described vertical monorail member 208 when the internal electrical/computational component 604 is attached to an MPS 102. One or both of each corresponding pair of electrodes 206a and 206b can be used to provide/receive power from the MPS 102.

Wiring attachments 706a and 706b are used to attach internal wiring 606 to the internal electrical/computational component 604. Each wiring attachment 706a and 706b is attached to one or more illustrated traces (for example, trace 710) on the PCB 708 to direct power to one or more described components of the internal electrical/computational component 604. Note that other traces may internal to the illustrated PCB 708 and not visible in FIG. 7.

Resettable fuse 702 is used to disable power provision/receipt in case of, for example, a power overload from an attached power supply, electrical short, electrical problem with an attached LED lighting strip, and the like. The resettable fuse 702 can be configured to reset automatically once a power problem is removed from the power plug 206. In some cases, the resettable fuse can be configured with a component externally accessible on the power plug 206 (for example, a depressible button) to manually reset the resettable fuse 702.

Bi-polarity functionality of the bi-polarity logic 704 can be used to provide real-time protection to LED lighting components attached to a power plug 206 if the power plug is attached to the MPS 102 in a reverse orientation to other power plugs 206. In other words, if the expected polarity is reversed, bi-polarity functionality can, in real-time, internally reverse the power flow through one or more components of the internal electrical/computational component 604 to prevent damage to the components or attached LED lighting devices. In this manner, power plugs can be attached in either orientation without worry of causing damage to either the MPSS 100 or attached LED lighting. In some implementations, bi-polarity logic 704 can be provided with a diode bridge/bridge rectifier.

The computational logic can be used to provide, for example, various customized lighting effects, a programming interface, network accessibility, and the like. In some implementations, the computational logic can store in a computer memory one or more applications/programs to provide customized lighting effects. In these implementations, the computer memory can be a non-volatile memory that retains settings if power is removed from the power plug 206. Customized lighting effects could include change of display patterns, color, brightness, flashing, timed ON/OFF, and the like. For example, a particular display vendor could wish to have their display lighting for a display shelf subtly brighter than that of a competitor in order to draw attention to their displayed products. In this case an individual power plug 206 connected to the lighting associated with a particular shelf can be configured to increase the brightness of attached LED lighting.

In some implementations, the computational logic can also provide wireline or wireless network access to each individual power plug 206. For example, each power plug 206 can be individually addressable on a wireless network and can be accessible on an application executed on a mobile computing device (for example, a smartphone, tablet, laptop computer, etc.) to allow particular settings for LED lighting attached to the addressed power plug 206. As an example, a lighting configuration application on a mobile device carried by a store manager could display a particular display shelf as a unit along with each associated power plug 206. Lighting settings for each power plug 206 could be accessed through the application and configured to adjust lighting parameters. The computational logic could also store status data for each power plug 206/attached LED lighting that can be retrieved and reviewed in order to detect issues in lighting, power, etc. related to the MPSS 100. In some implementations, individual power plugs 206 can be configured to communicate with other power plugs 206 (for example, wirelessly or wireline) to permit complex lighting display/effect interactions, synchronization between power plugs 206, and the like.

In some implementations, each power plug 206 can be configured with and to support a wireline programming port (not illustrated) that can be used to connect/program, retrieve data, reset, etc. the power plug 206. Wireline programming port can include USB, FIREWIRE, or other programming-type ports consistent with this disclosure.

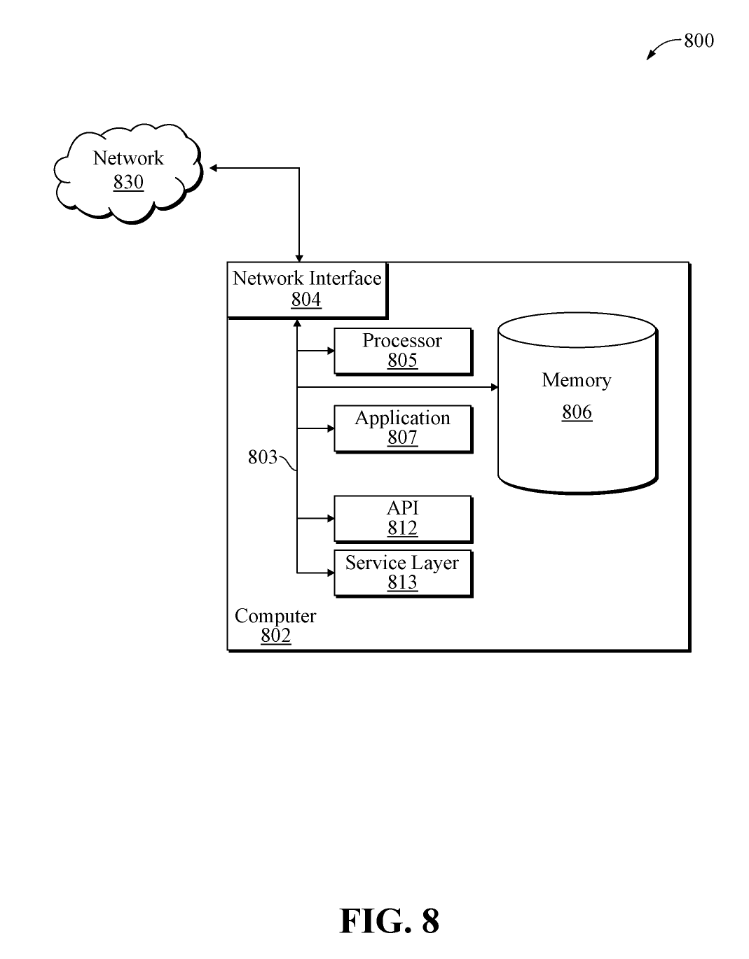

FIG. 8 is a block diagram of an exemplary computer that can be used with a monorail power strip system for shelving LED lighting, according to an implementation. The computer system 800 can provide computational functionalities associated with described algorithms, methods, functions, processes, flows, and procedures as described in the instant disclosure, according to an implementation. The illustrated computer 802 is intended to encompass any computing device consisted with this disclosure, including, but not limited to, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 802 may comprise a computer that includes an input device, such as a keypad, keyboard, touch screen, or other device that can accept user information, and an output device that conveys information associated with the operation of the computer 802, including digital data, visual, or audio information (or a combination of information), or a GUI.

The computer 802 can serve in a role as a client, network component, a server, a database or other persistency, or any other component (or a combination of roles) of a computer system for performing the subject matter described in the instant disclosure. The illustrated computer 802 is communicably coupled with a network 830. In some implementations, one or more components of the computer 802 may be configured to operate within environments, including cloud-computing-based, local, global, or other environment (or a combination of environments).

At a high level, the computer 802 is an electronic computing device operable to receive, transmit, process, store, or manage data and information associated with the described subject matter. According to some implementations, the computer 802 may also include or be communicably coupled with an application server, e-mail server, web server, caching server, streaming data server, business intelligence (BI) server, or other server (or a combination of servers).

The computer 802 can receive requests over network 830 from a client application (for example, executing on another computer 802) and responding to the received requests by processing the said requests in an appropriate software application. In addition, requests may also be sent to the computer 802 from internal users (for example, from a command console or by other appropriate access method), external or third-parties, other automated applications, as well as any other appropriate entities, individuals, systems, or computers.

Each of the components of the computer 802 can communicate using a system bus 803. In some implementations, any or all of the components of the computer 802, both hardware or software (or a combination of hardware and software), may interface with each other or the interface 804 (or a combination of both) over the system bus 803 using an application programming interface (API) 812 or a service layer 813 (or a combination of the API 812 and service layer 813). The API 812 may include specifications for routines, data structures, and object classes. The API 812 may be either computer-language independent or dependent and refer to a complete interface, a single function, or even a set of APIs. The service layer 813 provides software services to the computer 802 or other components (whether or not illustrated) that are communicably coupled to the computer 802. The functionality of the computer 802 may be accessible for all service consumers using this service layer. Software services, such as those provided by the service layer 813, provide reusable, defined business functionalities through a defined interface. For example, the interface may be software written in JAVA, C++, or other suitable language providing data in extensible markup language (XML) format or other suitable format. While illustrated as an integrated component of the computer 802, alternative implementations may illustrate the API 812 or the service layer 813 as stand-alone components in relation to other components of the computer 802 or other components (whether or not illustrated) that are communicably coupled to the computer 802. Moreover, any or all parts of the API 812 or the service layer 813 may be implemented as child or sub-modules of another software module, enterprise application, or hardware module without departing from the scope of this disclosure.

The computer 802 includes an interface 804. Although illustrated as a single interface 804 in FIG. 8, two or more interfaces 804 may be used according to particular needs, desires, or particular implementations of the computer 802. The interface 804 is used by the computer 802 for communicating with other systems in a distributed environment that are connected to the network 830 (whether illustrated or not). Generally, the interface 804 comprises logic encoded in software or hardware (or a combination of software and hardware) and operable to communicate with the network 830. More specifically, the interface 804 may comprise software supporting one or more communication protocols associated with communications such that the network 830 or interface's hardware is operable to communicate physical signals within and outside of the illustrated computer 802.

The computer 802 includes a processor 805. Although illustrated as a single processor 805 in FIG. 8, two or more processors may be used according to particular needs, desires, or particular implementations of the computer 802. Generally, the processor 805 executes instructions and manipulates data to perform the operations of the computer 802 and any algorithms, methods, functions, processes, flows, and procedures as described in the instant disclosure.

The computer 802 also includes a memory 806 that holds data for the computer 802 or other components (or a combination of both) that can be connected to the network 830 (whether illustrated or not). For example, memory 806 can be a database storing data consistent with this disclosure. Although illustrated as a single memory 806 in FIG. 8, two or more memories may be used according to particular needs, desires, or particular implementations of the computer 802 and the described functionality. While memory 806 is illustrated as an integral component of the computer 802, in alternative implementations, memory 806 can be external to the computer 802.

The application 807 is an algorithmic software engine providing functionality according to particular needs, desires, or particular implementations of the computer 802, particularly with respect to functionality described in this disclosure. For example, application 807 can serve as one or more components, modules, applications, etc. Further, although illustrated as a single application 807, the application 807 may be implemented as multiple applications 807 on the computer 802. In addition, although illustrated as integral to the computer 802, in alternative implementations, the application 807 can be external to the computer 802.

There may be any number of computers 802 associated with, or external to, a computer system containing computer 802, each computer 802 communicating over network 830. Further, the term “client,” “user,” and other appropriate terminology may be used interchangeably as appropriate without departing from the scope of this disclosure. Moreover, this disclosure contemplates that many users may use one computer 802, or that one user may use multiple computers 802.

Some implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory computer-storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware or software (or a combination of hardware and software), may interface with each other or the interface using an application programming interface (API) or a service layer (or a combination of API and service layer). The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API or service layer (or a combination of the API and the service layer) may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed computer-based implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A monorail power strip system (MPSS), comprising:
a ‘T’-shaped monorail power strip (MPS) including a vertical monorail member and a horizontal support member;
a power supply plug supplying power to the MPS from an electrical source; and
a power access plug for retrieving and transmitting power from the MPS, wherein the power supply plug and the power access plug are slideably-positionable along the length of the vertical monorail member.

2. The MPSS of claim 1, further comprising an electrical accessory receiving power from the power access plug.

3. The MPSS of claim 1, comprising an adhesive strip attached to the bottom of the MPS to allow attachment of the MPS to a surface.

4. The MPSS of claim 1, wherein the MPS comprises two electrode strips each providing differing polarity and situated on either side of the vertical monorail member.

5. The MPSS of claim 4, wherein the power supply plug and the power access plug snap onto the MPS using springily-biased electrodes that make contact with the electrode strips on either side of the vertical monorail member.

6. The MPSS of claim 1, wherein the power supply plug and the power access plug contain bi-polarity logic to adjust polarity of received electrical power in case either the power supply plug or the power access plug is reversed on the MPS.

7. The MPSS of claim 1, wherein the power supply plug and the power access plug contain a resettable fuse.

8. The MPSS of claim 1, wherein the power access plug contains computational logic providing networked access to the power access plug.

9. The MPSS of claim 8, wherein the computational logic provides functionality to adjust lighting parameters through the networked access.

10. The MPSS of claim 1, wherein the power supply plug and power access plug have differently-sized power supply connectors.

11. The MPSS of claim 1, wherein the vertical monorail member includes a notch that is configured to provide an outward spring bias in relation to the sides of the vertical member when engaged with the power supply plug or the power access plug to more securely engage the MPS with the power supply plug or the power access plug.

12. The MPSS of claim 1, wherein the horizontal member includes a notch that is configured to provide an upward spring bias in relation to the upper surface of the horizontal support member when engaged with the power supply plug or the power access plug to more securely engage the MPS with the power supply plug or the power access plug.

13. A monorail power strip apparatus, comprising:
a ‘T’-shaped monorail power strip (MPS) including a vertical monorail member and a horizontal support member;
a power supply plug supplying power to the MPS from an electrical source; and
a power access plug for retrieving and transmitting power from the MPS, wherein the power supply plug and the power access plug are slideably-positionable along the length of the vertical monorail member.

14. The apparatus of claim 13, further comprising an electrical accessory receiving power from the power access plug.

15. The apparatus of claim 13, comprising an adhesive strip attached to the bottom of the MPS to allow attachment of the MPS to a surface.

16. The apparatus of claim 13, wherein the MPS comprises two electrode strips each providing differing polarity and situated on either side of the vertical monorail member.

17. The apparatus of claim 16, wherein the power supply plug and the power access plug snap onto the MPS using springily-biased electrodes that make contact with the electrode strips on either side of the vertical monorail member.

18. The apparatus of claim 13, wherein the power supply plug and the power access plug contain bi-polarity logic to adjust polarity of received electrical power in case either the power supply plug or the power access plug is reversed on the MPS.

19. The apparatus of claim 13, wherein the power supply plug and the power access plug contain a resettable fuse.

20. The apparatus of claim 13, wherein the power access plug contains computational logic providing networked access to the power access plug.

21. The apparatus of claim 20, wherein the computational logic provides functionality to adjust lighting parameters through the networked access.

22. The apparatus of claim 13, wherein the power supply plug and power access plug have differently-sized power supply connectors.

23. The apparatus of claim 13, wherein the vertical monorail member includes a notch that is configured to provide an outward spring bias in relation to the sides of the vertical member when engaged with the power supply plug or the power access plug to more securely engage the MPS with the power supply plug or the power access plug.

24. The apparatus of claim 13, wherein the horizontal member includes a notch that is configured to provide an upward spring bias in relation to the upper surface of the horizontal support member when engaged with the power supply plug or the power access plug to more securely engage the MPS with the power supply plug or the power access plug.
